(19) United States
(12) Patent Application Publication
(10) Pub. No.: US 2013/0194510 A1
(43) Pub. Date: Aug. 1, 2013

(54) METHODS CIRCUITS DEVICES AND SYSTEMS FOR WIRELESS TRANSMISSION OF MOBILE COMMUNICATION DEVICE DISPLAY INFORMATION

(71) Applicants: Shay Freundlich, Sunnyvale, CA (US); David Shefler, Hod Hasharon (IL)

(72) Inventors: Shay Freundlich, Sunnyvale, CA (US); David Shefler, Hod Hasharon (IL)

(73) Assignee: AMIMON LTD, Herzlia (IL)

(21) Appl. No.: 13/634,250

(22) PCT Filed: Mar. 22, 2011
(86) PCT No.: PCT/IB2011/051210

§ 371 Date: Apr. 18, 2013

Related U.S. Application Data
(60) Provisional application No. 61/316,356, filed on Mar. 22, 2010.

(51) Int. Cl. H04N 5/38

(52) U.S. Cl. CPC H04N 5/38
USPC 348/723

(57) ABSTRACT

Disclosed are methods, circuits, devices and systems for transmission of a mobile device video display stream to an external display through a wireless source side video data transceiver. According to some embodiments, a resolution and/or frame rate of a video stream transmitted to the external display may be different from the resolution and/or frame rate of a video stream forwarded to the mobile device native display or display driver. One or more video layers and/or portions of the video stream transmitted to the external display may be different from those forwarded to the mobile device native display or display driver. A video stream transmitted to the external display may be split into two or more transmission streams.

### FIELD OF THE INVENTION

The present invention relates generally to the field of communication. More specifically, the present invention relates to methods, circuits, devices and systems for wireless transmission of mobile communication device display information to an external display.

### BACKGROUND

Wireless (Radio Frequency—RF) audio, video and data communication has rapidly evolved over the past century. Each time a new generation of higher performance and higher bandwidth wireless communication equipment is made available, there evolves demand for even higher performance equipment operating at even higher data rates. One of the more demanding applications/technologies requiring reliable transmission at very high data rates (e.g. gigabits/sec) is video transmission, especially high definition video.

Video bearing signals may be generated by various video sources, for example, a computer, a game console, a Video Cassette Recorder (VCR), a Digital-Versatile-Disc (DVD), or any other suitable video source. In many homes, for example, video content is received from content providers through either a cable or satellite link, usually at a Set-Top Box (STB), computer or other appliance. Computing devices such as personal computers, laptops, game consoles and mobile phones have also become popular media platforms.

In many cases, it may be desired to have a display, screen or projector at a location some distance (e.g. a few meters) from a video signal source. This trend is becoming more common as flat-screen displays (e.g., plasma or Liquid Crystal Display (LCD) televisions) are hung on walls. Connection of such a display or projector to a video source through cables is generally undesired for various reasons including installation convenience. Thus, wireless transmission of the video signals from a video source to a display screen (also known as a video sink) may be preferable. Various benefits provided with wireless interconnection between a video source and a video sink, include: (1) flexibility in positioning of a video source and a video sink relative to one another, (2) convenient (on-the-fly and/or dynamic) interconnection of each of one or more video sources to each of one or more video sinks, and (3) the ability to move a video source and/or video sink while maintaining video streaming connectivity.

With the evolution of mobile communication devices (e.g. cell-phones, smartphones, etc.) into powerful gaming and multimedia (i.e. music, images and video) acquisition, reception, storage, and presentation devices, there has been increasing interest in facilitating the interconnection of mobile communication devices with external displays and audio systems (hereinafter collectively referred to as media sinks, media presentation devices or sinks). Although processing power and data storage of relatively small communication devices is now sufficient to meet the resource requirements of even the most demanding multimedia applications, display sizes and audio projection capabilities of mobile communication devices are inherently limited by the need to keep these mobile devices relatively small and comfortable to transport. Some recent models of mobile communication devices include video and audio outputs to external displays. However, such outputs are wired outputs, making the transmission of the mobile device's display video impractical in situations such as those when the device receives an inbound call, initiates an outbound call, or when a user of the device wants to interact with the device, for example to play a videogame on the mobile device using the device's native interface (e.g. touch-screen controls, keypad buttons, accelerometers, etc.) inputs as game controls.

There are numerous challenges associated with RF transmission of video, along with associated audio, from a mobile video source to a video sink. There are even greater challenges when the video to be transmitted is high definition video. Due to the open and unforeseeable nature (e.g. noise, attenuation, fading, etc.) of wireless RF communication, various techniques have been developed and standards adopted in order to improve the probability of successful reception of a transmitted video signal.

Although many models of mobile communication devices are now available with IEEE 802.11 complaint and/or Bluetooth transceivers, these transceivers are generally not suited for transmission of high definition video and associated audio in an uncompressed format such that the video may be received and presented/projected substantially in real-time, without processing delays associated with compression and decompression of the video.

WHDI—Wireless Home Digital Interface is a standard for wireless high-definition video connectivity between a video source (e.g. cable box) and a video sink (e.g. display). It provides a high-quality, uncompressed wireless link which can support delivery of equivalent video data rates of up to 3 Gbit/s (including uncompressed 1080p) in a 40 MHz channel within the 5 GHz unlicensed band. Equivalent video data rates of up to 1.5 Gbit/s (including uncompressed 1080i and 720p) can be delivered on a single 20 MHz channel in the 5 GHz unlicensed band, conforming to worldwide 5 GHz spectrum regulations.

There is a need in the field of wireless video communication for improved methods, circuits, devices and systems for wireless transmission of mobile communication device display and/or audio information to an external display and/or audio presentation.

### SUMMARY OF THE INVENTION

According to embodiments, there is provided a mobile communication device including a Video Generator Circuit which may be adapted to generate a video stream intended for a native display on the device and a Video Stream Router which may be adapted to route to an External Display Output Circuit (EDOC) a transmission video stream at least partially corresponding to the display video stream. The EDOC may be adapted to wirelessly transmit the transmission video stream to an External Display in an uncompressed format.

According to some embodiments outing may include suppressing, dropping or stripping from the display video stream video portions associated with displayed controls or device status information. Routing may include interacting with the video generator circuit and/or receiving from the video generator circuit a transmission video stream of a higher resolution than the display video stream. Routing may include receiving from the video generator a video stream and degrading a resolution of a version of the video stream forwarded to a display driver of the device. Routing may include instructing the video generator to generate two video streams.

According to some embodiments, the video generator may be adapted to generate a relatively lower resolution video stream to be received by a native display driver, and/or to generator is a relatively higher resolution video stream to be routed to the EDOC.

According to some embodiments, the router may be adapted to intercept frequency coefficients of encoded video data concurrently or prior to decoding of the encoded data for display on the native display. The intercepted frequency coefficients may include Discrete Cosine Transform Coefficients.

According to some embodiments, the video generator may be adapted to generate a multi-resolution or a multi frame-rate video stream which is routed to both the EDOC and to the native display.

According to some embodiments, the EDOC may include processing circuits adapted to process for transmission one or more video blocks of a video steam. The processing circuits may be adapted to generate frequency coefficients associated with one or more video blocks. The processing circuits may be adapted to split a video stream into two transmission streams. The processing circuits may be adapted to associate relatively lower spatial frequency coefficients with a relatively higher priority transmission stream. The processing circuits may be adapted to associate relatively higher spatial frequency coefficients with a relatively lower priority transmission stream. The processing circuits may be adapted to associate relatively higher order bits with a relatively higher priority transmission stream. The processing circuits may be adapted to associate relatively lower order bits with a relatively lower priority transmission stream.

According to further embodiments, the processing circuits may be adapted to characterize one or more video blocks as static of dynamic. The processing circuits may be adapted to process those video blocks characterized as dynamic differently than those video blocks characterized as static. The processing circuits may be adapted to assign higher transmission priority to data associated with dynamic blocks than data associated with static blocks. The processing circuits may be adapted to route for transmission less data associated with static blocks than data associated with dynamic blocks. The processing circuits may be adapted to generate an indicator that a given block is static, wherein the indicator causes a sink (Side) transceiver to reuse data from a block corresponding to the given in a previous frame.

According to further embodiments, the EDOC may include a Source (side) transceiver adapted to wirelessly transmit one or more transmission streams to a sink (side) transceiver integral or functionally associated with an external display. The source transceiver may include two or more symbol mappers. The symbol mappers may include a quasi-continuous or quasi-analog symbol mapper. The source transceiver may include OFDM RX/TX RF circuitry and may be a multi-purpose (UMTS, Wi-Fi, WHDI, etc.) transceiver.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is diagram of an exemplary mobile communication device transmitting uncompressed high definition video (optionally: with audio) to each of one or more presentation devices, including a display and a projector, in accordance with some embodiments of the present invention;

FIG. 2A is a functional block diagram of an exemplary communication device including a video stream router which routes a video stream generated by a video generator to the device's native display and to an external display output circuit, in accordance with some embodiments of the present invention;

FIG. 2B is a functional block diagram of an exemplary communication device including a video stream router which routes different versions/instances of a video stream generated by a video generator for the device's native display to an external display output circuit, in accordance with some embodiments of the present invention;

FIG. 2C is a functional block diagram of an exemplary communication device including a video stream router which signals a video generator to generate difference video streams for the device's native display and for an external display output circuit, in accordance with some embodiments of the present invention;

FIG. 3 is a block diagram of an exemplary video stream/block baseband processor which processes for transmission data associated with a transmission video stream into two or more transmission streams forwarded to a source transceiver, in accordance with embodiments of the present invention;

FIG. 4 is a block diagram of an exemplary source transceiver, in accordance with embodiments of the present invention; and

FIG. 5 is a block diagram of an exemplary sink transceiver, in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, DVDs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will be apparent from the description below. In addition, embodiments of the present invention are not described with reference to any particular programming language. It will be appreciated that a variety of programming languages may be used to implement the teachings of the inventions as described herein.

It should be understood that some embodiments of the present invention may be used in a variety of applications. Although embodiments of the invention are not limited in this respect, one or more of the methods, devices and/or systems disclosed herein may be used in many applications, e.g., civil applications, military applications or any other suitable application. In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, and/or automobile A/V accessories. In some demonstrative embodiments the methods, devices and/or systems disclosed herein may be used in the field of Personal Computers (PC), for example, as part of any suitable desktop PC, notebook PC, monitor, and/or PC accessories. In some demonstrative embodiments the methods, devices and/or systems disclosed herein may be used in the field of professional A/V, for example, as part of any suitable camera, video camera, and/or A/V accessories. In some demonstrative embodiments the methods, devices and/or systems disclosed herein may be used in the medical field, for example, as part of any suitable endoscopy device and/or system, medical video monitor, and/or medical accessories. In some demonstrative embodiments the methods, devices and/or systems disclosed herein may be used in the field of security and/or surveillance, for example, as part of any suitable security camera, and/or surveillance equipment. In some demonstrative embodiments the methods, devices and/or systems disclosed herein may be used in the fields of military, defense, digital signage, commercial displays, retail accessories, and/or any other suitable field or application.

Although embodiments of the invention are not limited in this respect, one or more of the methods, devices and/or systems disclosed herein may be used to wirelessly transmit video signals, for example, High-Definition-Television (HDTV) signals, between at least one video source and at least one video destination. In other embodiments, the methods, devices and/or systems disclosed herein may be used to transmit, in addition to or instead of the video signals, any other suitable signals, for example, any suitable multimedia signals, e.g., audio signals, between any suitable multimedia source and/or destination.

Although some demonstrative embodiments are described herein with relation to wireless communication including video information, embodiments of the invention are not limited in this respect and some embodiments may be implemented to perform wireless communication of any other suitable information, for example, multimedia information, e.g., audio information, in addition to or instead of the video information. Some embodiments may include, for example, a method, device and/or system of performing wireless communication of A/V information, e.g., including audio and/or video information. Accordingly, one or more of the devices, systems and/or methods described herein with relation to video information may be adapted to perform wireless communication of A/V information.

The present disclosure corresponds to U.S. Provisional Application Ser. No. 61/316,356—filed on Mar. 22, 2010 and hereby incorporated by reference in its entirety.

The present invention includes methods, circuits, devices and systems for wireless transmission of mobile communication device display information (i.e. images and video) to a presentation device such as a display (media sink). According to some embodiments of the present invention, one or more layers of a mobile device display video stream may be routed to an external display output circuit, which external display output circuit may include a baseband processing circuit/logic/module and a source (side) transceiver which may wirelessly transmit data associated with or derived from the video stream to a corresponding video sink (side) transceiver (integral, coupled or otherwise functionally associated with a media sink). The video stream routed to the external display output circuit may include relatively higher resolution video frames than the video stream routed to the mobile device's native display. According to some embodiments of the present invention, mobile device control and status images/video may be stripped, removed, or otherwise suppressed from a video stream routed to the external display output circuit. According to further embodiments of the present invention, the external display output circuit may transmit the video stream to the media sink transceiver in an uncompressed format—optionally mitigating and/or substantially eliminating processing related latency.

According to some embodiments of the present invention, a graphics processor of the mobile device may output a video stream as a sequence of frame data sets (i.e. complete pixel information for each pixel of each frame). The graphics processor may output the video stream at or near High Definition Television (“HDTV”) resolution and frame-rate standards. One version or instance of the output video stream may be routed to a display controller of the mobile device and a second version or instance of the video stream may be routed to an external display output circuit according to some embodiments of the present invention. The display controller and the source transceiver may be connected to the graphics processor through the same video data bus or connectors or through different busses/connectors.

According to further embodiments of the present invention, the graphics processor may substantially simultaneously output two video streams, either through the same or through different output pins, each representing the same video information but at different resolutions and/or frame-rates. One of the streams (e.g. the lower resolution and/or lower frame-rate stream) may be routed to the display controller, while the other stream (e.g. the higher resolution and/or frame-rate stream) may be routed to the external display output circuit.

According to yet further embodiments of the present invention, the graphics processor may be adapted to output a given HDTV (or similar quality) video stream having a given resolution and/or frame-rate, and the display controller may be adapted to display the stream at a lower resolution and/or lower frame-rate than the given resolution and/or frame-rate. According to the same embodiment, the source transceiver of the external display output circuit may transmit the video stream at or near the given resolution and/or frame-rate.

According to some embodiments of the present invention, the mobile device source transceiver may include processing logic adapted to convert frame related pixel data (e.g. Y-Cr-Cb components) into discrete cosine (or other time/frequency domain) coefficients. According to further embodiments of the present invention where the processing logic is part of a GPU, multiple blocks of pixel data may be processed in parallel. The source transceiver may be adapted to transmit all or portions of the coefficients as QAM and/or OFDM symbols. According to further embodiments of the present invention, the processing logic may be adapted to forward for transmission only a portion of the bits associated with a given coefficient (e.g. more significant bits) using conventional QAM/OFDM encoding and transmission methods, while forwarding for transmission a second portion of the coefficient bits (e.g. less significant bits) as a fine constellation point in a quasi-analog transmission scheme. The second bit portions may be transmitted as a value associated with a specific fine constellation point in accordance with a mapping where values in numerical proximity with one another are associated with fine constellation points in spatial proximity with one another on the mapping place.

According to further embodiments of the present invention, low spatial frequency coefficients (i.e. DC coefficients, and/or near DC coefficients) may be represented in a coarse, (i.e. digital) manner. The low spatial frequency coefficients may be represented as one or more of a plurality of constellation points of a symbol by performing a quantization on their values and mapping them. According to some embodiments of the present invention, relatively higher frequency coefficients and the quantization errors of the DC and the near DC components may be mapped as fine-constellation points thus providing the fine granularity (i.e. analog-like) values that at an extreme fineness provides for a continuous representation of these values.

According to some embodiments of the present invention, the external display output circuit may include a transmitter adapted for transmission over a telecommunication network (e.g. wide area network, metropolitan area network, or local area network) and adapted to transmit data using transmission symbols. According to further embodiments of the present invention, the external display output circuit may include a baseband processing circuit in addition to an RF transmission circuit. The source transceiver may include a baseband bypass/switch circuit for up-converting and transmitting video information based transmission symbols without additional baseband processing. According to further embodiments of the present invention where there is no baseband bypass, the video information based transmission symbols may be transmitted by an additional RF transmission circuit designed for up-converting and transmitting video/audio content based transmission symbols.

According to some embodiments of the present invention, the source baseband processing circuit and associated sink baseband processing circuit may perform dynamic and static video frame and video block differentiation, and may handle the transmission and reception of the transform coefficients of different types of video frame and blocks differently. According to further embodiments of the present invention, a first portion or subset of the coefficients may be transmitted using a first RF data link and a second portion or subset of the coefficients may be transmitted using a second RF link. One of the RF links may be more reliable than the other RF link. One set of coefficients may include more spatial information than another set of coefficients.

According to further embodiments of the present invention, selection of which subset of coefficients of a given block to transmit, or of which coefficients to transmit over a more reliable RF link and which subset to transmit over a less reliable link, may be based on a comparison of the given video block's pixel data against corresponding pixel data of one or more corresponding video blocks from one or more previous video frames stored in a buffer. According to further embodiments of the present invention where transmission of the video block data may not be absolutely in real time, a comparison of the given video block's data may also include a comparison against corresponding blocks from subsequent video frames. The comparison of a video block's data against the data of a corresponding video block in another frame may provide an indication as to the spatial/temporal deviation of the block relative to the corresponding video block in the previous frame—indicating whether the video block is static (i.e. substantially the same) or dynamic (i.e. substantially different) relative to the corresponding block in the previous frame.

According to further embodiments of the present invention, a comparison of the given block against one or more corresponding blocks may produce an indicator of the spatial/temporal difference between the compared blocks. If this indicator (e.g. deviation value) is below a given threshold, indicating the block is relatively similar to the previous block, the coefficient selector module may select a first subset of coefficients for transmission. If the indicator is above the given threshold, indicating a dynamic block, the selector module may select a second subset of coefficients for transmission, which second set may be fully or partially overlapping with the first subset. According to some embodiments of the present invention, the first subset of coefficients may include less or more spatial data than the second subset of coefficients. According to further embodiments of the present invention, for video blocks associated with indicators indicating a deviation/difference above the threshold value, the second subset of coefficients may be selected for transmission over a more reliable RF link and the first subset may be selected for transmission over a second, less reliable, RF link.

According to some embodiments of the present invention, when a given video block is determined to be static, the coefficient selector may select coefficients which were not already transmitted for the corresponding block in the previous frame. An indicator indicating that a block is static may be transmitted instead of or along with the coefficients. An image reconstruction module (e.g. decoder and graphics circuit) on the receiver side (e.g. video sink) may receive the indicator and in response may keep the previously generated video block image and may use nay received coefficients to augment or enhance the previously generated video block image. The coefficient set selected for a video block designated as static may also include coefficients previously transmitted for a corresponding block from the previous frame. These retransmitted coefficients, which were transmitted as part of the previous frame, may be used by a video frame or video block reconstruction module to enhance the displayed video image by averaging corresponding coefficient values, thereby reducing possible image generating errors due to fidelity lose during transmission/reception. Coefficients selected for a video block designated as static and used by the reconstruction module to enhance a previously generated video image may be termed “complimenting coefficients”.

According to some embodiments of the present invention, the graphics processor, or another circuit functionally associated with the graphics processor, may be adapted to output an external display output circuit video stream with substantially identical video information as a display video stream routed to the display controller, but routed to the source transceiver and formatted at least partially as a set of discrete frequency transform values and/or data bits associated with discrete frequency transform values. The external display output circuit video stream at least partially composed of discrete frequency transform values may have been received in and/or stored on the mobile device as discrete frequency transform values. Alternatively, the discrete frequency transform values may be generated from frame pixel data by the graphics processor or by a functionally associated circuit such as a discrete cosine transform circuit or any other time to frequency domain transform circuit.

According to further embodiments of the present invention, video information contained in the transceiver video stream may be a subset of the video information contained in the mobile device display stream. For example, video layers associated with the mobile device's interface and/or control input/output images/videos (e.g. media player border and/or status indicators, touch screen button projections, etc) may be withheld from or removed from the transceiver stream. Thus, a user may control media streaming using native device user interface controls without seeing the control related images on the external screen. According to further embodiments of the present invention, some mobile device input/output control related images/videos may be added to the transceiver stream in certain situations, such as call indicator or caller ID when the mobile communication device receives an inbound call or message.

According to further embodiments of the present invention, a communication device's native inputs such as touch-screen keys and finger strokes, physical keys/buttons, speech recognition, Interactive Voice Response, and accelerometers may be used by a user to control video being transmitted to the external display. A user may interact and use the mobile device as a game controller for a videogame generated/rendered by the mobile device's processor(s)—for example using the communication device's native accelerometers to sense a swing of a tennis racket within a tennis game generated/rendered by the device's processor(s) and viewed on the external display.

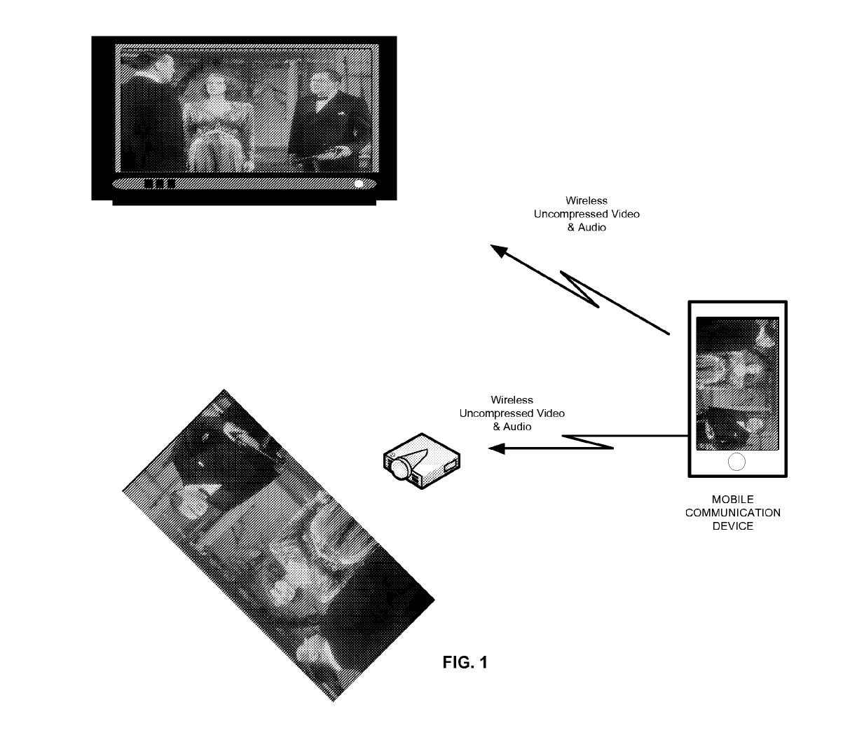

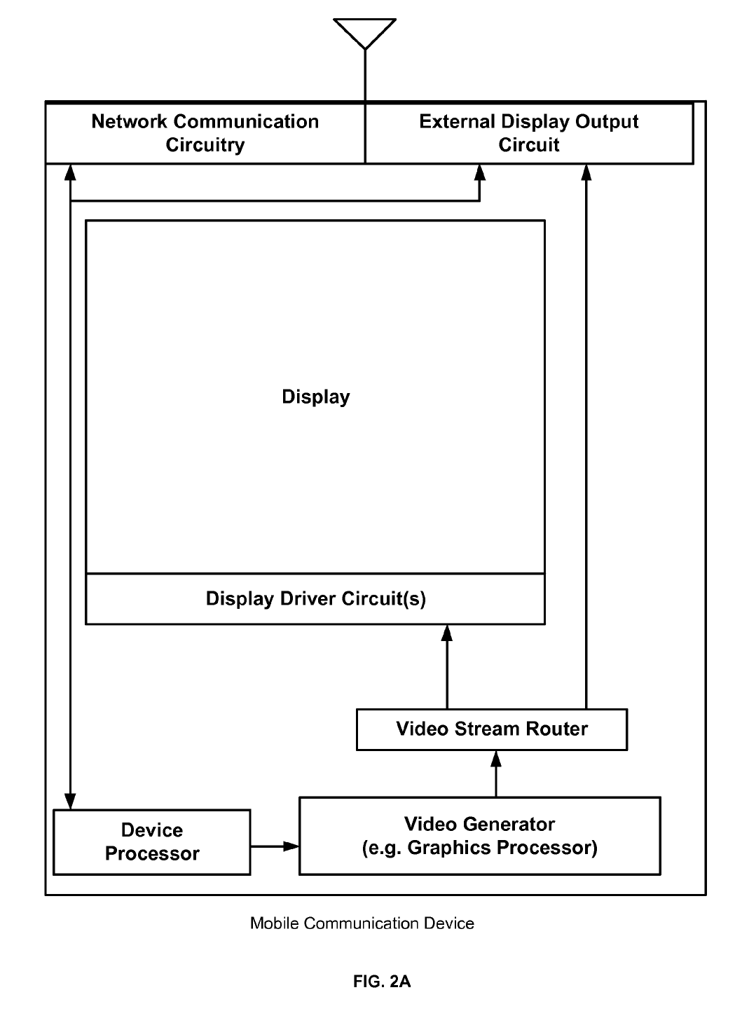

Turning now to FIG. 1, there is shown a diagram of an exemplary mobile communication device transmitting uncompressed high definition video (optionally: with audio) to each of one or more presentation devices, including a display and a projector, in accordance with some embodiments of the present invention. The communication device may transmit HDMI compliant video and audio with substantially no processing related latency due to absence of compression of the video as part of transmission processing. Any suitable presentation device known today or to be devised in the future may be suitable.

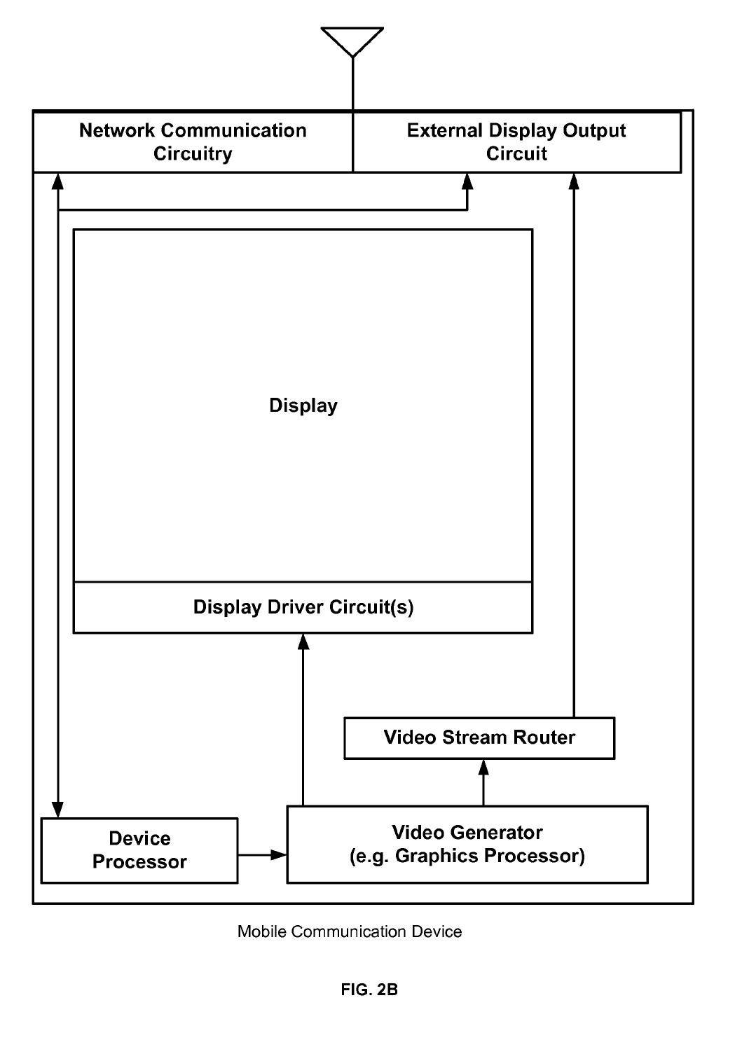

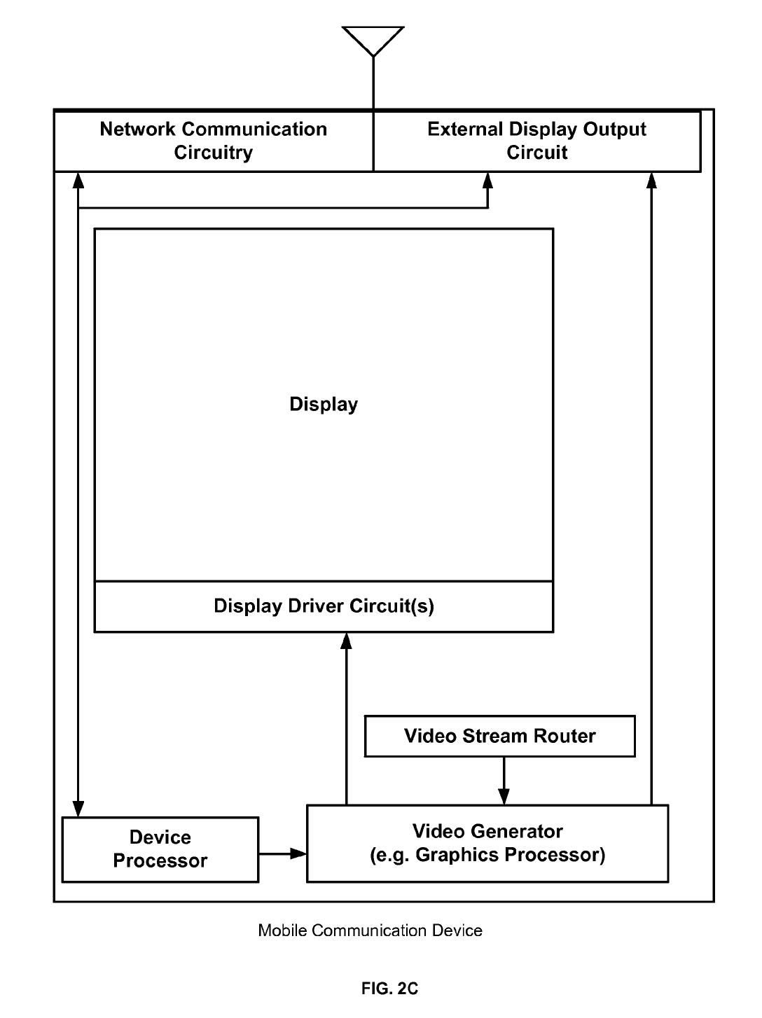

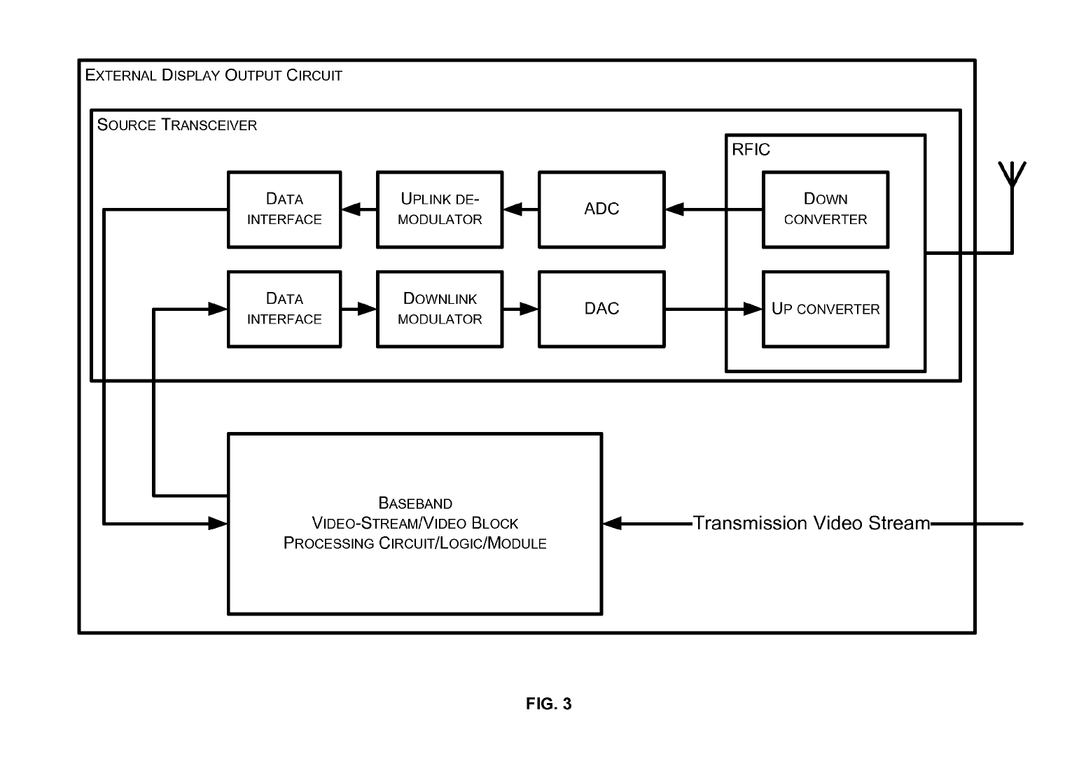

Turning now to FIG. 2A, there is shown a functional block diagram of an exemplary communication device including a video stream router which routes a video stream generated by a video generator to the device's native display and to an external display output circuit, in accordance with some embodiments of the present invention. FIG. 2B is a functional block diagram of an exemplary communication device including a video stream router which routes different versions/instances of a video stream generated by a video generator for the device's native display to an external display output circuit, in accordance with some embodiments of the present invention. While FIG. 2C is a functional block diagram of an exemplary communication device including a video stream router which signals a video generator to generate different video streams for the device's native display and for an external display output circuit.

The Video Stream Router may be adapted to route some or all of a Communication Device's Video Display Stream to the External Display Output Circuit. Routing may include suppressing, dropping or stripping from Display Stream video portions associated with displayed controls (e.g. buttons). Routing may include interaction with Mobile Device Video Generator (e.g. GPU). Routing may include receiving from the Mobile Device Video Generator a video stream of a higher resolution than the video stream received by the Device Native Display Driver. Routing may include receiving from the Mobile Device Video Generator a video stream and degrading the resolution of a version of the video stream sent to the device native display driver. Routing may include instructing the Mobile Device Video Generator to provide two versions of the Display Video Stream: (1) a relatively lower resolution video stream to be received by the Device Native Display Driver; and (2) a relatively higher resolution video stream to be routed to the External Display Output Circuit.

The router may be adapted to intercept Frequency Coefficients of encoded video data (e.g. stored MPEG files or received MPEG streams) concurrently or prior to decoding (e.g. by Mobile Device Video Generator) of the encoded data for display on the Device's Native Display. Intercepted Frequency Coefficients may include Discrete Cosine Transform Coefficients. Copies of Intercepted frequency coefficients may be routed to the External Display Output Circuit.

The Mobile Device Video Generator may be adapted to generate one or more Video Display Streams accessible to the Video Stream Router. It may generate a stream with resolution and/or frame-rate higher than suitable for Native Display but suitable for External Display. The stream may be routed unchanged by Video Stream Router to External Display Output Circuit. The steam may be degraded by the Video Stream Router or by the Device Native Display Driver before being presented on the Native Display.

The generator may generate a multi-resolution and/or multi frame-rate stream which is routed unchanged by (e.g. by the Video Stream Router) to the External Display Output Circuit and to the Device Native Display Driver. The Device Native Display Driver may use/decode the lower resolution for the Native Display.

The Generator may generate a higher resolution stream for the Video Stream Router than for the Device Native Display Driver. Optionally, the stream for the Video Stream Router is generated responsive to a signal from the Video Stream Router or some other Associated Circuitry.

The Generator may generate a stream for the Video Stream Router/External Display Output Circuit without (i.e. removing, stripping, inhibiting) displayed controls or control video layer. It may generate a stream intended for the Video Stream Router/External Display Output Circuit including external display specific controls or control video layer (e.g. caller-ID of inbound call). The Generator may provide or route to the Video Stream Router copies of Frequency Coefficients of encoded video data concurrent or prior to decoding for the display on the Device's Native Display. The Generator may generate the stream intended for the Video Stream Router/External Display Output Circuit as a stream of frequency coefficients.

Turning now to FIG. 3, there is shown a block diagram of an exemplary video stream/block baseband processor which processes for transmission data associated with a transmission video stream into two or more transmission streams forwarded to a source transceiver, in accordance with embodiments of the present invention. The baseband Processing Circuits/Logic/Module may be adapted to process one or more video blocks of the Video Display Stream for transmission. It may generate frequency coefficients associated with one or more video blocks of a Video Stream. It may split a Video Stream into two transmission streams.

Data associated with lower spatial frequency coefficients may be associated with a higher fidelity/reliability/priority transmission stream. Data associated with higher spatial frequency coefficients may be associated with a lower fidelity/reliability/priority transmission stream.

Higher order bits of a frequency coefficient may be associated with a higher fidelity/reliability/priority transmission stream. Lower order bits of a frequency coefficient may be associated with a lower fidelity/reliability/priority transmission stream.

The baseband processor may characterize (e.g. as static of dynamic) one or more video blocks of the Display Video Stream. It may process those video blocks characterized as dynamic differently than those video blocks characterized as static. For example, it may assign higher transmission priority to data associated with dynamic blocks than data associated with static blocks. It may route for transmission less (or none) of the data associated with static blocks than the data associated with dynamic blocks. Instead of routing for transmission data associated with a given block characterized as static, the processor may route for transmission (e.g. to a Source (Side) Transceiver) an indicator that the given block is Static—thereby indicating to a Sink (Side) Transceiver to reuse data from a block corresponding to the given in a previous frame.

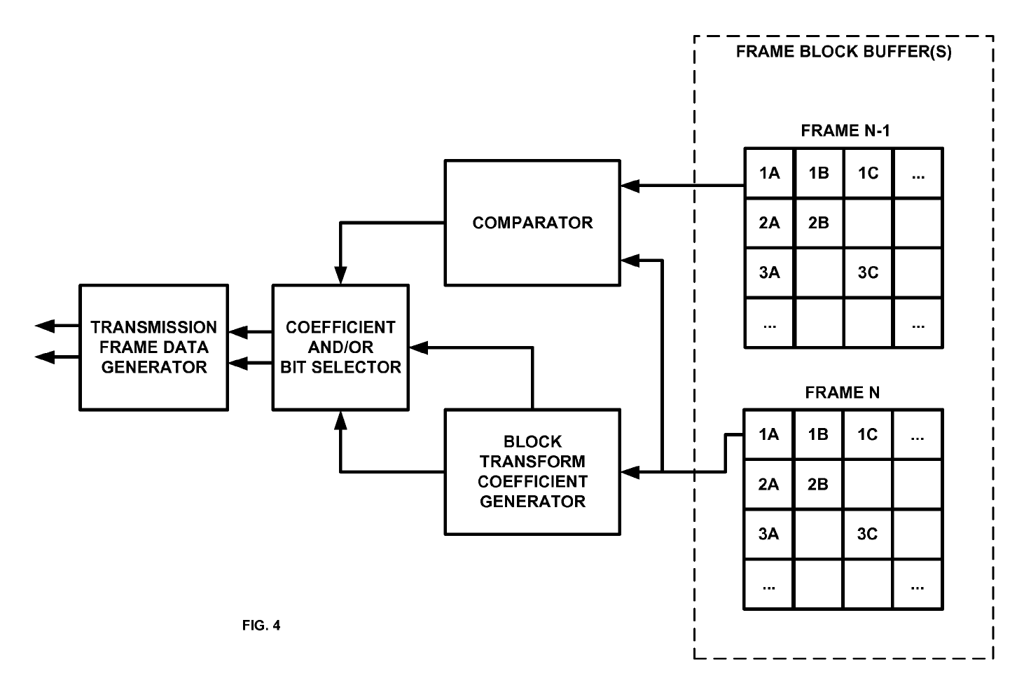

Turning now to FIG. 4, there is shown a block diagram of an exemplary source transceiver, in accordance with embodiments of the present invention. The source (side) transceiver may be adapted to wirelessly (i.e. over an RF Data Link) transmit the one or more transmission streams (e.g. as part of a transmission frame) to a sink (side) transceiver integral or functionally associated with an external display. It may include one or more symbol mappers including conventional symbol mappers (e.g. for higher reliability/priority transmission streams) and one or more fine (e.g. quasi continuous) symbol mappers for (e.g. lower reliability/priority transmission streams). It may include OFDM RX/TX RF circuitry. It may be part of a multi-purpose (UMTS, Wi-Fi, WHDI, etc.) transceiver. It may include a multi-mode (UMTS, Wi-Fi, WHDI, etc.) baseband processing circuit/logic/module, and/or it may include a bypass/switch circuit for allowing each of a set of baseband processing circuits/logic/modules access to RF TX/RX circuitry.

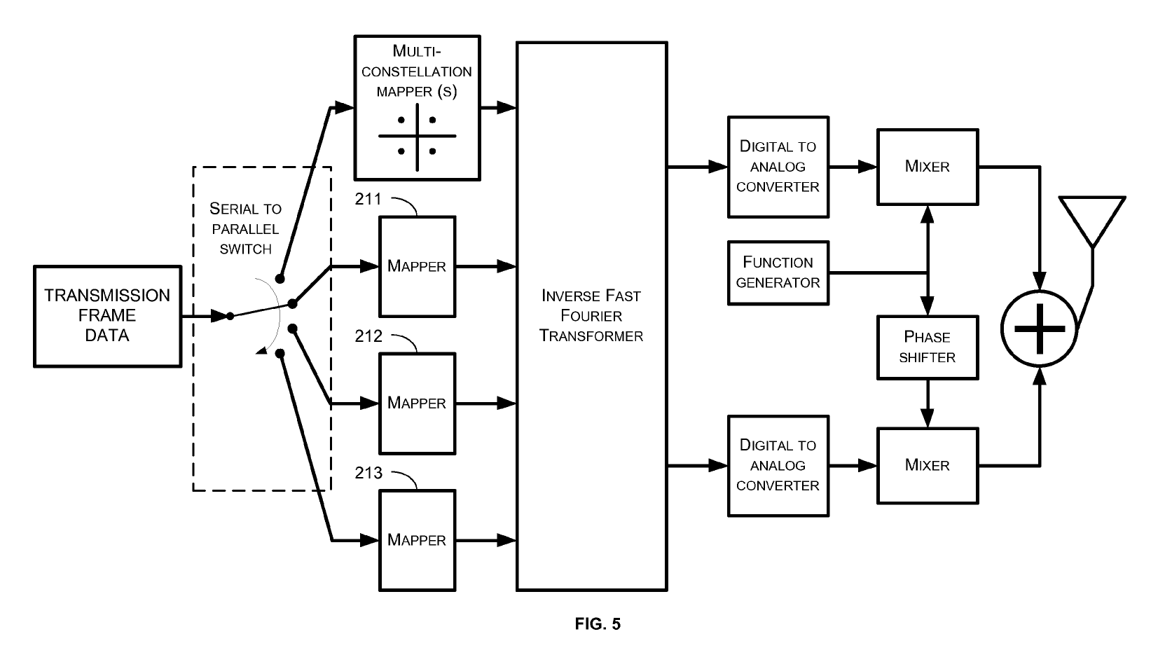

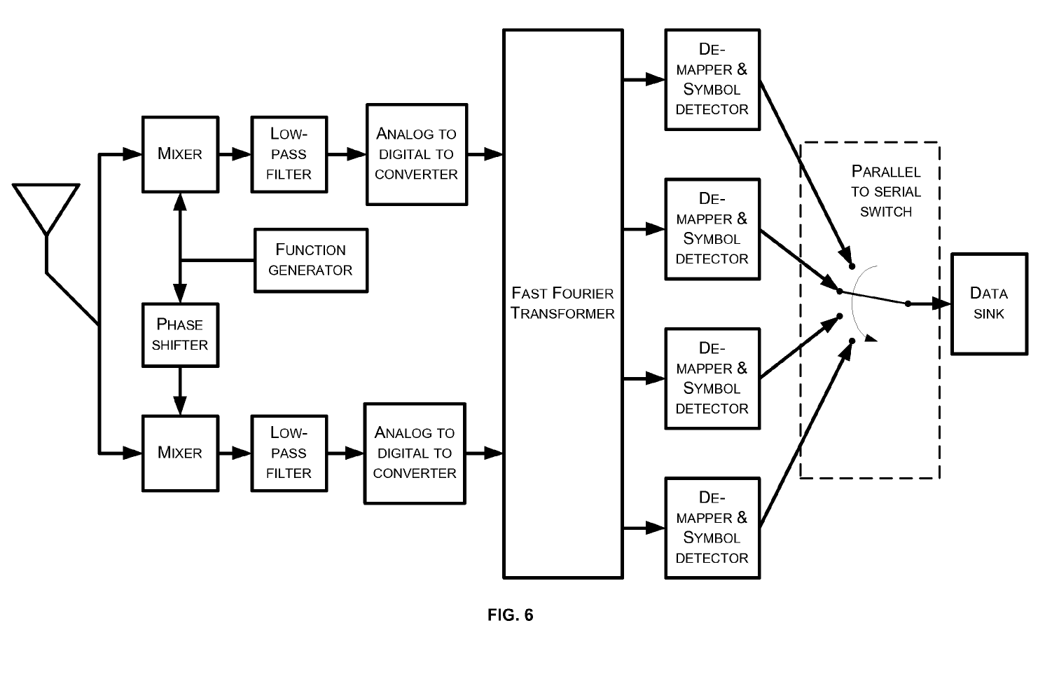

FIG. 5 is a block diagram of an exemplary sink transceiver, in accordance with embodiments of the present invention.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infra-red, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A mobile communication device comprising
a Video Generator Circuit adapted to generate a native display video stream intended for a native display on said device;
a Video Stream Router adapted to route to an External Display Output Circuit (EDOC) a transmission video stream at least partially corresponding to the display video stream; and
wherein said EDOC is adapted to wirelessly transmit the transmission video stream to an External display in an uncompressed format.

2. The device according to claim 1, wherein routing includes suppressing, dropping or stripping from the display video stream video portions associated with displayed controls or device status information.

3. The device according to claim 1, wherein routing includes interacting with said video generator circuit.

4. The device according to claim 3, wherein routing includes receiving from the video generator circuit a transmission video stream of a higher resolution than the display video stream.

5. The device according to claim 4, wherein routing includes receiving from the video generator a video stream and degrading the resolution of a version of the video stream forwarded to a display driver of said device.

6. The device according to claim 3, wherein routing includes instructing the video generator to generate two video streams.

7. The device according to claim 6, wherein said video generator is adapted to generate a relatively lower resolution video stream to be received by a native display driver.

8. The device according to claim 6, wherein said video generator is adapted to generate a relatively higher resolution video stream to be routed to the EDOC.

9. The device according to claim 1, wherein said router is adapted to intercept frequency coefficients of encoded video data concurrently or prior to decoding of the encoded data for display on the native display.

10. The device according to claim 9, wherein the intercepted frequency coefficients include Discrete Cosine Transform Coefficients.

11. The device according to claim 1, wherein said video generator is adapted to generate a multi-resolution or a multi frame-rate video stream which is routed to both the EDOC and to the native display.

12. The device according to claim 1, wherein said EDOC includes processing circuits adapted to process for transmission one or more video blocks of a video steam.

13. The device according to claim 12, wherein the processing circuits are adapted to generate frequency coefficients associated with one or more video blocks.

14. The device according to claim 12, wherein the processing circuits are adapted to split a video stream into two transmission streams.

15. The device according to claim 14, wherein the processing circuits are adapted to associate relatively lower spatial frequency coefficients with a relatively higher priority transmission stream.

16. The device according to claim 14, wherein the processing circuits are adapted to associate relatively higher spatial frequency coefficients with a relatively lower priority transmission stream.

17. The device according to claim 14, wherein the processing circuits are adapted to associate relatively higher order bits with a relatively higher priority transmission stream.

18. The device according to claim 14, wherein the processing circuits are adapted to associate relatively lower order bits with a relatively lower priority transmission stream.

19. The device according to claim 12, wherein the processing circuits are adapted to characterize one or more video blocks as static of dynamic.

20. The device according to claim 19, wherein the processing circuits are adapted to process those video blocks characterized as dynamic differently than those video blocks characterized as static.

21. The device according to claim 19, wherein the processing circuits are adapted to assign higher transmission priority to data associated with dynamic blocks than data associated with static blocks.

22. The device according to claim 19, wherein the processing circuits are adapted to route for transmission less data associated with static blocks than data associated with dynamic blocks.

23. The device according to claim 19, wherein the processing circuits are adapted to generate an indicator that a given block is static, wherein the indicator causes a sink (Side) transceiver to reuse data from a block corresponding to the given in a previous frame.

24. The device according to claim 1, wherein said EDOC includes a Source (Side) Transceiver adapted to wirelessly transmit one or more transmission streams to a Sink (Side) Transceiver integral or functionally associated with an external display.

25. The device according to claim 24, wherein said source transceiver includes two or more symbol mappers.

26. The device according to claim 25, wherein one of the symbol mappers is a quasi-continuous symbol mapper for lower priority transmission streams.

27. The device according to claim 24, wherein said source transceiver includes OFDM RX/TX RF circuitry.

28. The device according to claim 27, wherein said source is a multi-purpose (UMTS, Wi-Fi, WHDI, etc.) transceiver.
